(19) United States
(12) Patent Application Publication
(10) Pub. No.: US 2003/0016099 A1
(43) Pub. Date: Jan. 23, 2003

(54) Tunable resonator and method of tuning the same

(76) Inventors: David J. Manseau, Boulder Creek, CA (US); Daniel P. Teuthorn, San Jose, CA (US)

Correspondence Address: Ingrid McTaggart, 702 SE 5th Avenue, Hillsboro, OR, 97123, US

(21) Appl. No.: 09/911,183

(22) Filed: Jul. 23, 2001

(51) Int. Cl. H01P 1/20

(52) U.S. Cl. 333/205

(57) ABSTRACT

A resonator and method of tuning the same comprises at least one resonator wherein each resonator includes a tuning element coupled thereto. The tuning element may be physically attached to the resonator or may be positioned adjacent thereto. The tuning element is trimmed to change the frequency characteristic of the resonator by a slight amount. The width of the tuning element is less than the width of the resonator element of the microstrip filter so that trimming of the tuning element can be conducted with precision.

### 1. TECHNICAL FIELD

The present invention relates to a tunable resonator and method of tuning the same and, more particularly, to a tunable resonator such as a microstrip filter including tuning elements coupled or positioned adjacent to said filter, wherein said elements are physically trimmed after manufacture of the filter so as to fine tune the filter by altering its resonant frequency. The present invention will be described in terms of a band pass filter but the invention may be used in many devices, such as band pass filters, band reject filters, traps, oscillators, phase shifters, amplifiers, equalizers or other devices using resonators.

2. DESCRIPTION OF RELATED ART

Band-pass filters are used for allowing a certain frequency band to be passed there through while suppressing all other frequencies. Prior art microstrip band-pass filters typically comprise a plurality of microstrips plated on a substrate. Coarse tuning of these microstrip band-pass filters is accomplished by manufacturing the strips in a predetermined length. Further tuning of these microstrip filters is accomplished by cutting off the end of one or more of the microstrips across the entire width of the microstrip. In another trimming method, a triangular corner area of the microstrip is severed. Both these tuning methods produce large and difficult to control changes in the microstrip. Often times, too much material is removed, requiring some metal to be reattached or scrapping of the device. In a production process, this prior art tuning method is time consuming and essentially irreversible.

Accordingly, it would be desirable to provide a microstrip band-pass filter which can be more finely tuned than prior art filters so as to compensate for variations in dielectric and plating and wherein the time of the tuning process is reduced.

### SUMMARY OF THE INVENTION

The present invention comprises at least one resonator wherein each resonator has a tuning element coupled thereto. The tuning element may be physically attached to the resonator or may be positioned adjacent thereto. The tuning element is trimmed to change the frequency characteristic of the resonator by a slight amount.

The preferred embodiment of the present invention provides at least one microstrip resonator which is formed on a substrate, wherein the strips each include a narrow tuning element coupled to each strip. The narrow tuning elements typically have a width less than the width of the strips. Accordingly, by trimming, i.e., cutting, the narrow elements, fine tuning of the resonator, such as in the form of a band-pass filter, can be accomplished, thereby slightly increasing the resonator's resonant frequency. The frequency of the filter, therefore, typically is built low so that the filter is tuned upwardly. However, the filter typically is built within a predetermined specification range so that trimming may not be necessary.

In one embodiment the tuning elements are attached to the microstrips in the form of tuning arms. In another embodiment, another type of tuning element may be coupled to the ends of the strips, wherein these tuning elements, also called tuning extensions, each comprise multiple tuning stubs connected by narrow rungs. To fine tune this embodiment of the resonator, the rung between adjacent tuning stubs is severed. This will slightly increase the filter's resonant frequency. In still another embodiment, the filter may include attached tuning arms and tuning extensions positioned proximate to the microstrips. This embodiment may be tuned by trimming either or both of the two types of tuning elements.

In particular, the present invention includes a tunable device comprising: at least one resonator including a body portion and a tuning element extending outwardly from said body portion, said tuning element having a width dimension less than a width dimension of said body portion, and wherein said tuning element is adapted for being trimmed so as to change a resonant frequency of said resonator. The invention further comprises a method of tuning a resonator, including the steps of: providing a resonator having a body portion and a tuning element coupled to and extending outwardly from said body portion, said tuning element having a width dimension less than a width dimension of said body portion; and making a cut in said tuning element so as to separate an end region of said tuning element from a remainder of said tuning element so as to change a resonant frequency of said resonator. The invention still further comprises a tunable microstrip filter including: a filter element and a tuning element positioned adjacent said filter element, said tuning element comprising at least two wide portions connected by a narrow portion having a width dimension less than a width dimension of said filter element, and wherein said narrow portion of said tuning element is adapted for being severed so as to change a resonant frequency of said filter.

Accordingly, it is an object of the present invention to provide a resonator that can be finely tuned after manufacture of the resonator.

It is another object of the present invention to provide a resonator including tuning extensions that are trimmed to fine tune the resonator.

### BRIEF DESCRIPTION OF THE DRAWINGS

FIG. 1 is a top view of a prior art microstrip band-pass filter;

FIG. 2 is a top view of the resonator of the present invention, in the form of a microstrip band-pass filter, including narrow tuning arms extending from ends of the microstrips;

FIG. 3 is a top view of another embodiment of the microstrip band-pass filter including tuning stub extensions positioned adjacent ends of the microstrips;

FIG. 4 is a top view of another embodiment of the microstrip band-pass filter including tuning stub extensions positioned adjacent ends of the microstrips and elongate tuning arms extending from ends of the microstrips;

FIGS. 5A through 5D are detailed top views of the tuning method of the present invention for a band-pass filter having elongate tuning arms and tuning stub extensions positioned adjacent the microstrips; and

FIGS. 6 through 17 show other embodiments of the tuning elements of the present invention. FIG. 18 shows a top view of the resonator of the present invention, in the form of a microstrip band-pass filter, including narrow tuning arms extending from ends of the microstrips, wherein the microstrips have different widths and different spacings from one another.

### DETAILED DESCRIPTION OF THE PREFERRED EMBODIMENTS

FIG. 1 shows a top view of a prior art microstrip band-pass filter 10 including four band-pass filter strips 12, 14, 16 and 18. Strip 12 includes an input lead 20 and strip 18 includes an output lead 22. Coarse tuning of this band-pass filter is accomplished by manufacturing the strips in a predetermined length 24 as required for a particular application. Each strip may be formed in any predetermined length or width, and with any desired spacing between adjacent strips, as is appropriate for a particular application. To further tune the filter, an end of one or more of the strips may be severed by making a cut 26 through the strip, i.e., a plurality of the strips may be tuned to tune the filter. The cut may or may not also extend through the substrate material 28 on which the strip is supported. The first cut is made through an entire width 30 of the strip, very close to one end of the strip. In another method, not shown, a triangular corner of the end of the strip is severed. The response, including linear S parameters and time domain measurements, of the filter is then measured. If further tuning is desired, additional cuts may be made. Accordingly, multiple cuts 32, 34 and 36, may be made, with measurements taken between each cut to further tune the device. This iterative process can be time consuming and is largely irreversible. In other words, once the width of a strip is severed, the severed portion 38 cannot be satisfactorily rejoined to the remainder of the strip during full scale production processing. Moreover, severing the entire width of the strip often results in an uncontrolled amount of material, i.e., too much material, being severed from the filter strip, thereby making small frequency adjustments very difficult.

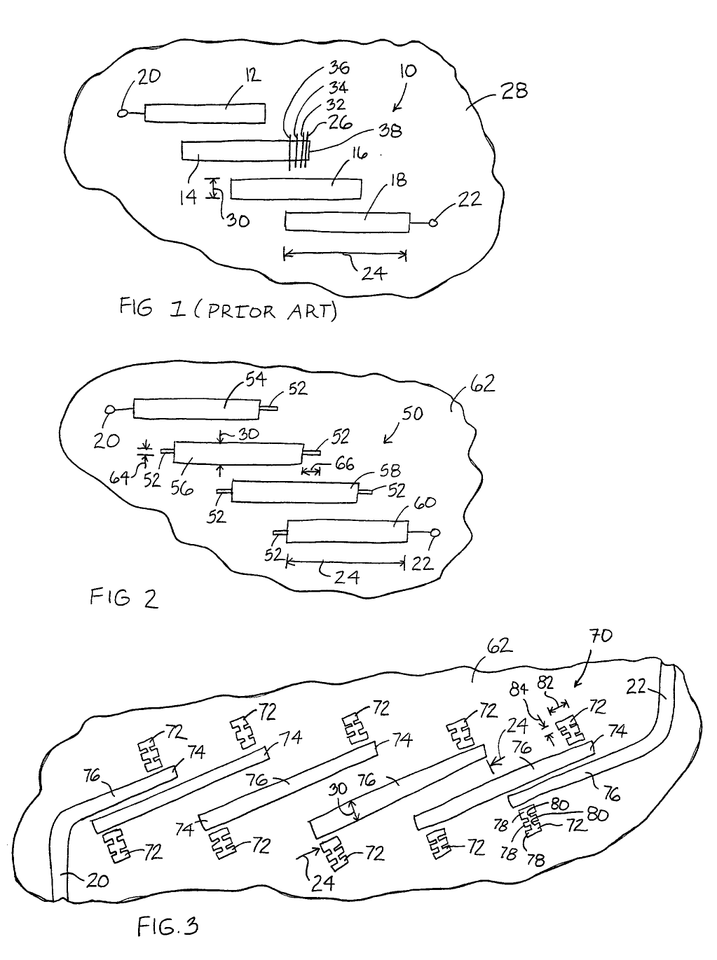

FIG. 2 shows a top view of a resonator 50, in the form of a microstrip bandpass filter, of the present invention including narrow tuning elements 52, also called turning arms, extending from ends of each of the microstrips 54, 56, 58 and 60. Microstrips 54 through 60 may each also be referred to as a body portion of the resonator. As stated above, the resonator of the present invention may also be used in other devices, such as band reject filters, traps, oscillators, phase shifters, amplifiers, equalizers or any other device using resonators. A band-pass filter is shown merely for ease of illustration. The resonator may be manufactured in the form of a microstrip, CPW, slot, strip-line, coaxial cable, pin, or any kind of resonator using conductive material. In other embodiments elongate tuning elements 52 may be positioned on only one end of each of the strips or may be positioned on only a few of the strips which comprise filter 50. The extensions may also be positioned extending perpendicular to or at another angle with respect to a length 24 of the strips, and may be positioned somewhat inwardly from an end of the strips, such as nearer a central region of the microstrip, as is desired for a particular application and accordingly to space constraints of the substrate. Placement of the tuning elements near a central region will lessen the sensitivity of the narrow elements whereas placement of the tuning element or elements near the end of the microstrip will result in a higher sensitivity of the narrow element, i.e., trimming of the narrow elements will have more of a tuning effect when the narrow elements are placed close to the end of the microstrip.

Strip 54 includes input lead 20 and strip 60 includes output lead 22. Those skilled in the art will understand that four strips are shown merely for example and that in different embodiments other numbers, arrangements, sizes and shapes of strips may be utilized. The strips and tuning elements typically are plated on substrate 62 by known processes, as will be understood by those skilled in the art. The strips and elements may also be placed on the substrate by the processes of gluing, rolling, screening, sputtering, cutting (such as with an LPKF device (Registered Trademark of LPKF Laser and Electronics AG)) or other well known processes. The tuning elements typically will have specific tolerances called for in the fabrication drawings so that the small sized tuning elements, when compared with the larger lines on the substrate, are not over-etched. When the tuning elements have been over-etched, the elements will be too small to have much effect on the microstrips during tuning.

Substrate 62 may be manufactured of any suitable material, taking into account the frequency of operation of the device, what type of structure is to be printed on the substrate, changes in electrical parameters due to temperature, and cost concerns. For example, the following substrate materials may be used: fiberglass resin, teflon, teflon-ceramic composite, Alumina, and Beryllium Oxide. The microstrips and the tuning elements in one embodiment are manufactured of 0.7 mil thick copper. In the embodiment discussed herein, the copper strip has a further coating of nickel followed by a coating of gold. These additional coatings prevent oxidation of the copper strip, as is known in the art. However, other materials may also be used for fabrication and protection of the microstrips and the tuning elements.

In the preferred embodiment, each of tuning elements 52, which comprise tuning arms in FIG. 2, has a width 64 that is smaller than, and typically on the order of one fifth of width 30 of the strips, or filter lines, 54, 56, 58 and 60. Width 64 of the tuning arms typically is measured normal to an elongate length of the tuning arm. During operation of the filter, the tuning elements function as electrically short high impedance transmission lines. Width 64 of the tuning elements may be any width as is desired and that is less than width 30 of the strips. Elements 52 may have any length 66 as is desired for a particular application, but typically have a length 66 on the order of one tenth of the length 24 of the strip. By “on the order of” Applicants mean within one order of magnitude of the value in both directions, i.e., one order of magnitude larger and one order of magnitude smaller than the value. The length 66 of tuning elements 52 should be sufficient to allow for ample material to be removed from the strips for tuning purposes, as will be described in more detail below. In the embodiment shown in FIG. 2, tuning arms 52 typically are manufactured of the same plating material, and are deposited on substrate 62 at the same time as strips 54, 56, 58 and 60. Accordingly, tuning arms 52 are electrically connected to each of their respective strips.

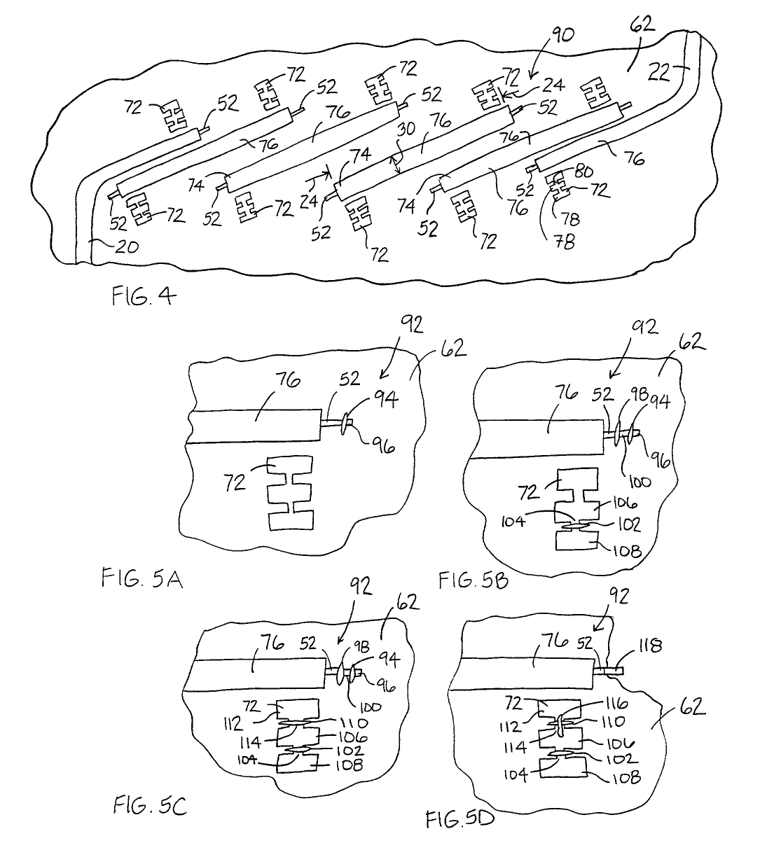

FIG. 3 shows a top view of another embodiment of a microstrip band-pass filter 70 including tuning elements in the form of tuning stub extensions 72 positioned adjacent, but not in contact with, ends 74 of microstrips 76. During operation of the filter, the adjacent extensions 72 are coupled to the strips, also called filter lines or elements, by fringing fields due the extensions' proximity to the filter elements. Filter 70 further comprises an input lead section 20 and an output lead section 22 and is positioned on substrate 62. Each of proximity extensions 72 may be positioned perpendicular to a length 24 of the strips and adjacent ends 74 of the strips. Each extension 72, in the embodiment shown, comprises three stub portions 78, also called wide portions or regions, connected by narrow rung portions 80, also called narrow portions or regions. These narrow rung portions may be severed during the tuning process, as will be described in more detail below. In the embodiment shown, stub portions 78 each have a width 82 approximately the same as width 30 of the strips. Width 82 of the stub portions may be less than, equal to or greater than the width of the microstrips. The stub portions also are shown having a height 84 on the order of half that of width 30 of the strips. Rung portions 80 have a width less than the width of the strip, and as shown have a width on the order of one quarter the width 82 of stub portions 78. Those skilled in the art will understand that different numbers, shapes, sizes and arrangements of wide and narrow regions may be utilized as is desired for particular applications and that the size and shape of the extensions shown is only one of many possible variations.

FIG. 4 shows a top view of another embodiment of a microstrip band-pass filter 90 similar to the embodiment shown in FIG. 3, but further comprising tuning elements 52 attached to and extending from ends 74 of microstrips 76. In this embodiment, coarse tuning is accomplished by manufacturing strips 76 in a predetermined length 24. Those skilled in the art will understand that the size, shape and placement of the resonators for each individual strip may vary. In other words, the tuning arms and the tuning extensions for the strips may vary in size, shape or placement from one strip to another strip within a single resonator. Fine tuning of the filter is accomplished by first severing a portion or portions of attached elements 52, also called tuning arms. Further fine tuning is then accomplished by severing one or more of stub portions 78 of extensions 72. The tuning process will now be described in more detail.

FIGS. 5A through 5D show detailed top views of the tuning method of the present invention for a band-pass filter 92 having a narrow tuning arm 52 and a tuning stub extension 72 positioned adjacent a microstrip 76. Only a portion of one strip 76 is shown for purposes of illustration. In a first step of the tuning method, strip 76 is manufactured on substrate 62 having a predetermined length. Filter characteristics such as the linear S parameters and time domain of the filter are then measured. If an increase in the frequency of the resonator is desired, a first cut 94 is made in arm 52 thereby severing an end region 96 of the arm from a remainder of arm 52. Cut 94 is shown having a width so as to illustrate that severed end region 96 is no longer in physical contact with the remainder of arm 52. Cutting of the arm may also be referred to as trimming, tuning or severing of the arm. The cut typically is made with a sharp instrument such as an exacto blade, but any trimming method can be utilized such as the use of lasers, chemical processes, or other mechanical processes. Cut 94 creates a gap between end region 96 and the remainder of arm 52 such that the resonant frequency of that resonator is increased. If the resonant frequency requires further increases, then additional cuts can be made, as will be described below.

Referring to FIG. 5B, a second cut 98 is made in arm 52 between cut 94 and strip 76. This shortens the effective length of arm 52 and further increases the resonant frequency of resonator 92. In other words, section 100 is severed from strip 76.

Utilizing the tuning method as described herein, predictable frequency tuning of ten percent, five percent, and even less than one percent of the resonant frequency, can been achieved. Due to the method of the present invention, designing the filter to be wider in bandwidth to compensate for manufacturing tolerances is not required. Accordingly, the filter of the present invention is an improvement over prior art filters that do not include trimmable elements. In particular, such prior art filters are often designed to be wider in bandwidth than necessary so that the prior art filter may not work as well in rejecting signals that the prior art filter was initially designed to attenuate.

Referring to FIG. 5C, if finer tuning is required, a third cut 102 can be made in rung 104 between stub portions 106 and 108. During tuning, the farthest-most rung 108 from the microstrip 76 typically is isolated first. A filter characteristic measurement is then performed. If further tuning is required, then the next farthest most stub 106 from the microstrip 76 is severed, as shown by cut 110. Fourth cut 110 is made between stub portions 106 and 112 in rung 114. This somewhat isolates strip 76 from fringing fields due to rung 106. The filter characteristics may then be measured. As stated above, the stub extensions typically are positioned near an end of the microstrips so that the extensions will have the greatest effect on the frequency of the resonators. Moreover, placement of the tuning stubs near a middle portion of a microwave filter line is generally not possible due the proximate placement of other microstrip filter lines. Tuning of these “bar bell” shaped tuning elements allows for tuning to within 1.0 to 0.1 percent of the center frequency of the resonator.

FIG. 5D shows repair of cut 110. In most cases, when tuning elements are trimmed, the trimmed portion is so small that some over trimming is acceptable, i.e., the filter's characteristics are still within the desired specification window. However, gross over trimming typically is corrected. In particular, the measured frequency determined with respect to FIG. 5C may show that too much material was removed during the prior steps of the tuning process. Accordingly, one may desire to reattach stub 106 to stub 112. To accomplish this task, a conductive trace 116 typically is connected over cut 110 thereby reconnecting stubs 112 and 106.

In the case of attached tuning arms 52, the severed portion of the arm is generally completely removed from the substrate. In this situation, copper ribbon 118 may be connected to the end of the trimmed tuning arm to reverse or correct the trimming process. The copper ribbon generally hangs off the end of arm 52. Of course, the size of copper ribbon 118 is exaggerated for purposes of illustration. In other embodiments conductive paint or conductive epoxy may also be used to reverse or correct the trimming process. Accordingly, a process is described wherein small amounts of material may be severed from the microstrip in incremental steps thereby allowing for fine tuning of the device, i.e., allowing for finer frequency control than prior art methods. The process requires less time than prior art methods because less material is severed with each cut, due to the thin width of the tuning elements. Accordingly, the cuts can be made more quickly because there is less risk of over trimming. Moreover, the process is reversible in that bus wires, copper ribbon or other correction means can be used to reconnect severed portions of the tuning elements.

Due to the inverse relationship between frequency and wavelength, trimming the tuning elements always raises the frequency of the filter. For example, a filter having a center frequency of approximately 5 GHz could be trimmed to 30 MHz precision with the use of attached tuning arms, and could be trimmed to 5 MHz precision with the use of adjacent tuning extensions. Of course, other filters manufactured in different sizes and of different materials, will have different center frequencies and frequency changes when subjected to the tuning method of the present invention. The present invention may be used for resonators operating in the frequency range of microwaves to millimeter wave frequencies.

FIG. 6 shows a single trap embodiment of the present invention wherein microstrip 76 is positioned perpendicular to a half wave transmission line 140.

FIG. 7 shows a microstrip 76 including three narrow tuning arms 52a, 52b and 52c, each having a different length. During tuning of this device one or more of the tuning arms may be trimmed at any point along the length of the tuning arms.

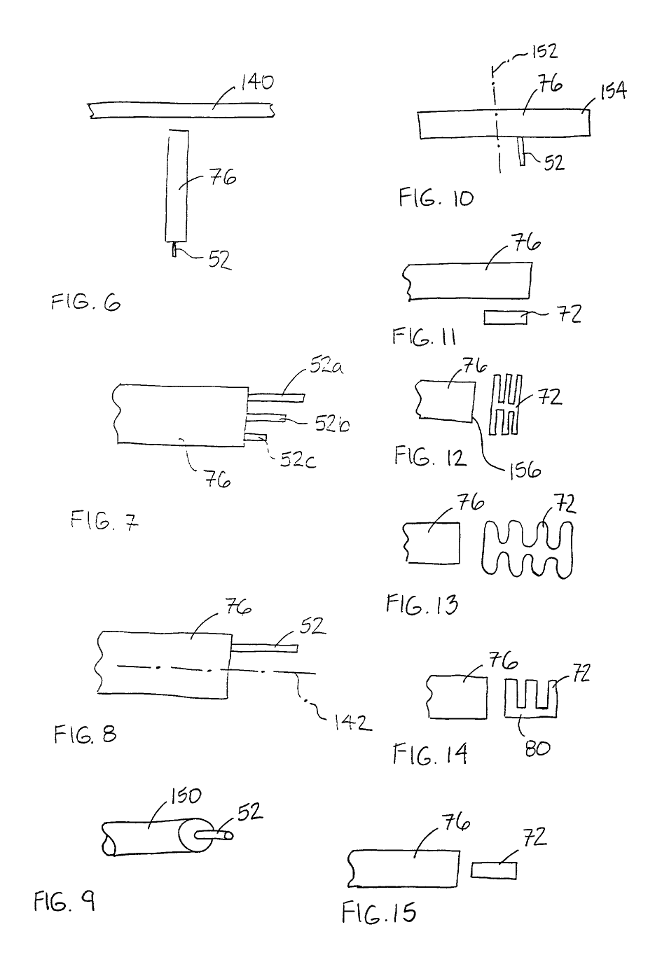

FIG. 8 shows a microstrip 76 including a single narrow tuning arm 52 positioned offset from an elongate axis 142 of the microstrip. Accordingly, placement of the narrow extension will affect the tuning sensitivity.

FIG. 9 shows a three-dimensional pin 150 having a tuning arm 52 extending therefrom.

FIG. 10 shows a tuning strip 76 having a tuning arm 52 extending outwardly therefrom, wherein said tuning arm is positioned inwardly toward a central axis 152 of the strip, as opposed to an outer edge 154 of the strip. Applicants believe that positioning of the tuning element inwardly from outer edge 154 of strip 76 will lower the sensitivity of tuning element 52, making the tuning control finer.

FIG. 11 shows a strip 76 having a tuning extension 72 coupled to the strip, i.e., adjacent but not in contact with the strip. The length of tuning extension 72 is positioned parallel to the length of strip 76.

FIG. 12 shows a tuning strip 76 having a bar-bell shaped tuning extension 72 positioned adjacent the strip, wherein the outer width of the bar-bell shaped tuning extension may be greater than a width of the strip, but wherein the width of the narrow rung portion is narrower than the width of the strip.

FIG. 13 shows a tuning strip 76 having a bar-bell shaped tuning extension 72 positioned adjacent the strip, wherein the extension has rounded edges.

FIG. 14 shows a tuning strip 76 having a tuning extension 72 positioned adjacent the strip, wherein the extension is connected by rungs 80 at a lower edge of the tuning extension.

FIG. 15 shows tuning strip 76 having a tuning extension 72 positioned adjacent the strip, wherein tuning extension 76 is shaped like tuning arms 52 shown in previous embodiments.

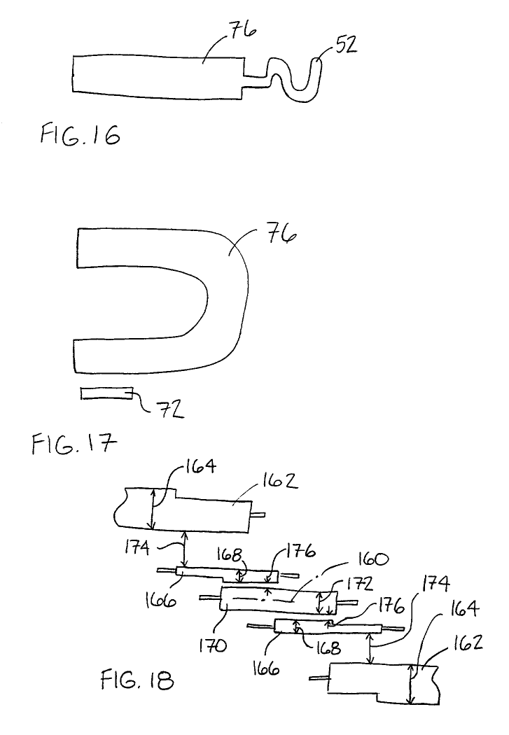

FIG. 16 shows a tuning strip 76 having a tuning arm 52 extending therefrom, wherein tuning arm 52 has a curved shaped.

FIG. 17 shows a curved tuning strip 76 having a tuning element 72 positioned adjacent the tuning strip.

FIG. 18 shows a top view of a resonator of the present invention, in the form of a microstrip band-pass filter. The resonator includes narrow tuning arms extending from ends of the microstrips, wherein the microstrips have different widths and different spacings from one another. In particular, the strips are generally positioned symmetrically about a central axis 160 such that outermost strips 162 each have a similar width 164 and central strips 166 each have a similar width 168. Centermost strip 170 has a width 172 different than the width of strips 162 and strips 166. Additionally, strips 166 are each spaced a distance 174 from their corresponding adjacent strip 162, which is different from a spacing 176 of strips 166 from centermost strip 170. Accordingly, this figure illustrates that any arrangement, size and shape of the strips may be utilized for the present invention.

In the above description numerous details have been set forth in order to provide a more through understanding of the present invention. It will be obvious, however, to one skilled in the art that the present invention may be practiced using other equivalent designs.

We claim:

1. A tunable device comprising:
at least one resonator including a body portion and a tuning element extending outwardly from said body portion, said tuning element having a width dimension less than a width dimension of said body portion, and wherein said tuning element is adapted for being trimmed so as to change a resonant frequency of said resonator.

2. The tunable device of claim 1 wherein said body portion is a microstrip.

3. The tunable device of claim 1 wherein said device comprises a filter.

4. The tunable device of claim 1 wherein said tuning element has a length dimension less than a length dimension of said body portion.

5. The tunable device of claim 1 wherein said tuning element comprises an elongate region physically connected to said body portion.

6. The tunable device of claim 1 wherein said tuning element is physically disconnected from said body region.

7. The tunable device of claim 1 wherein said tuning element comprises at least two stub portions positioned adjacent said body portion.

8. The tunable device of claim 7 wherein said at least two stub portions are connected by a rung, wherein said width dimension of said tuning element is measured across said rung.

9. The tunable device of claim 1 wherein said body portion is manufactured of copper plated on a substrate.

10. The tunable device of claim 1 wherein said device is tuned to within 0.1 percent of a center frequency of the resonator.

11. The tunable device of claim 1 wherein said device has a center frequency in a range from a microwave frequency to a millimeter wave frequency.

12. The tunable device of claim 1 further including a transmission line, and wherein an elongate axis of said body portion is positioned perpendicularly to said transmission line.

13. The tunable device of claim 1 wherein said resonator is manufactured within one percent of a center bandwidth of said resonator, and wherein said tuning element is trimmed so as to change a resonant frequency of said resonator to be within 0.1 percent of said center bandwidth.

14. The tunable device of claim 1 wherein said resonator is manufactured within five percent of a center bandwidth of said resonator, and wherein said tuning element is trimmed so as to change a resonant frequency of said resonator to be within one percent of said center bandwidth.

15. The tunable device of claim 1 wherein said resonator comprises a portion of a device chosen from the group consisting of a band pass filter, a band reject filter, a trap, an oscillator, a phase shifter, an amplifier and an equalizer.

16. A method of tuning a device including a resonator, comprising the steps of:
providing a resonator having a body portion and a tuning element coupled to and extending outwardly from said body portion, said tuning element having a width dimension less than a width dimension of said body portion; and
making a cut in said tuning element so as to separate an end region of said tuning element from a remainder of said tuning element so as to change a resonant frequency of said resonator.

17. The method of claim 16 further comprising making a second cut in said remainder of said tuning element so as to further change the resonant frequency of said resonator.

18. The method of claim 16 wherein said tuning element comprises an elongate tuning arm attached to said body portion.

19. The method of claim 16 wherein said tuning element comprises at least two stub extensions connected by a rung, and wherein said at least two stub extensions are positioned adjacent said body portion.

20. The method of claim 19 wherein said step of making a cut in said tuning element comprises cutting said rung.

21. The method of claim 16 further comprising reconnecting said end region of said tuning element to said remainder of said tuning element.

22. The method of claim 16 further comprising measuring characteristics of said device including said resonator, wherein said characteristics are chosen from the group consisting of a linear S parameter and a time domain response characteristic.

23. A tunable microstrip filter comprising:
a filter element and a tuning element positioned adjacent said filter element, said tuning element comprising at least two wide portions connected by a narrow portion having a width dimension less than a width dimension of said filter element, and wherein said narrow portion of said tuning element is adapted for being severed so as to change a frequency characteristic of said filter.

24. The filter of claim 23 further comprising a substrate wherein said filter element and said tuning element are positioned on said substrate.

25. The filter of claim 23 further comprising a second tuning element connected to and extending outwardly from said filter element, wherein said second tuning element is adapted for being severed so as to change a frequency characteristic of said filter.

26. The filter of claim 23 wherein said filter includes a plurality of filter elements each including a tuning element positioned adjacent thereto.

27. The filter of claim 25 further comprising a third tuning element connected to and extending outwardly from said filter element opposite said second tuning element, wherein said third tuning element is adapted for being severed so as to change a frequency characteristic of said filter.

28. A tunable device comprising:
a body portion and a tuning element extending outwardly therefrom, said tuning element having a width dimension less than a width dimension of said body portion, and wherein said tuning element is adapted for being trimmed across said width dimension of the tuning element so as to change a capacitance of said tunable device.
